(19) United States
(12) Patent Application Publication
(10) Pub. No.: US 2006/0221388 A1
(43) Pub. Date: Oct. 5, 2006

(54) Method for controlling image forming apparatus, server and system, program product of the method, computer readable medium of the product

(76) Inventors: Takashi Yoshikawa, Kanagawa (JP); Takahiko Uno, Tokyo (JP)

Correspondence Address: HARNESS, DICKEY & PIERCE, P.L.C., P.O. BOX 8910, RESTON, VA, 20195, US

(21) Appl. No.: 11/370,048

(22) Filed: Mar. 8, 2006

(30) Foreign Application Priority Data
Mar. 8, 2005 (JP) 2005-064145

(51) Int. Cl. G06F 3/12

(52) U.S. Cl. 358/1.15

(57) ABSTRACT

A method is disclosed for controlling a server for a plurality of image forming apparatuses. The method includes allocating a print number, within which an image forming apparatus is allowed to print, to each image forming apparatus. It further includes receiving a request of an additional print number from the first image forming apparatus, sending an inquiry to a second image forming apparatus to inform a remaining print number of the second image forming apparatus, and receiving the information of the remaining print number of the second image forming apparatus, sending an order to provide a required print number to the second image forming apparatus. Finally, the method includes receiving the required print number provided from the second image forming apparatus and allocating the print number provided from the second image forming apparatus to the first image forming apparatus.

### BACKGROUND

1. Field

This patent specification generally describes a method for controlling an image forming apparatus, server and system which includes a plurality of image forming apparatuses connected to the server. This patent specification also generally describes a program product of the method, a computer readable medium having the program product, and an image forming system having the apparatus.

2. Discussion of the Background

A background multifunction peripheral (MFP) apparatus has been widespread as an enhanced digital-controlled image forming apparatus and is generally capable of copying, printing, faxing, scanning, storing, and so on. The background MFP apparatus has been used in various kinds of places such as almost every type of offices, shopping stores, etc.

When the background MFP apparatus is used in shopping stores, it can offer versatile service to users on a chargeable basis. For this, the background MFP apparatus is provided with a function of service management to control services to users such as printing, for example. In the control of the printing services, for example, a print number usually depends on a prepayment amount in cash or electronic money with bank cards, prepaid cards, or the like.

The background MFP apparatus is also widely utilized in office environments where a plurality of people are working and sharing office equipment including the background MFP apparatus. In many cases, more than one background MFP apparatus are installed and shared by the employees. In such an environment, each background MFP apparatus is also provided with the function of service management to control services to the users such as printing, for example, in order mainly to realize energy savings such as suppression of unnecessary printing performances.

In this service management, the background MFP apparatus stores registered members (i.e., the office employees) and a print number available to each one of the registered members. Such an available print number stored in the background MFP apparatus is decremented by one upon each performance of printing.

### SUMMARY

This patent specification describes at least one embodiment of a novel method for controlling a server for a plurality of image forming apparatuses which includes steps, allocating a print number, within which an image forming apparatus is allowed to print, to each image forming apparatus, receiving a request of an additional print number from the first image forming apparatus, sending an inquiry to a second image forming apparatus to inform a remaining print number of the second image forming apparatus, receiving the information of the remaining print number of the second image forming apparatus, sending an order to provide a required print number to the second image forming apparatus, and receiving the required print number provided from the second image forming apparatus and allocating the print number provided from the second image forming apparatus to the first image forming apparatus.

This patent specification further describes at least one embodiment of a novel method for controlling an image forming apparatus of a plurality of image forming apparatuses which includes steps, receiving an allocation of a print number, within which an image forming apparatus is allowed to print, from a server, requesting an additional print number to the server and receiving a supplementary allocation of a print number which the server obtains from another image forming apparatus.

Further, this patent specification describes at least one embodiment of a novel method for controlling an image forming system having a plurality of image forming apparatuses which includes steps, allocating a print number, within which an image forming apparatus is allowed to print, to each image forming apparatus by a server, requesting an additional print number from the first image forming apparatus to the server, sending an inquiry to inform a remaining print number of a second image forming apparatus from the server, returning the information of the remaining print number of the second image forming apparatus to the server, sending an order to provide a required print number to the second image forming apparatus, providing the required print number from the second image forming apparatus to the server and allocating the print number provided from the second image forming apparatus to the first image forming apparatus.

### BRIEF DESCRIPTION OF THE DRAWINGS

A more complete appreciation of the disclosure and many of the attendant advantages thereof will be readily obtained as the same becomes better understood by reference to the following detailed description of example embodiments when considered in connection with the accompanying drawings, wherein:

FIG. 1 is a block diagram of an image forming system according to an example embodiment;

FIG. 2 is a block diagram of a multi function peripheral (MFP) apparatus as an example of the image forming apparatus of FIG. 1;

FIG. 3 is a block diagram of a server which controls a print number on the MFP apparatus;

FIG. 4 is a hardware block diagram of a client personal computer;

FIG. 5 is a software block of a server;

FIG. 6 is another sequence chart of an allocation process to allocate print numbers to the MFP apparatuses;

FIG. 7 is an user-login screen which is displayed at the MFP;

FIG. 8 is an available-number-conformation screen;

FIG. 9 is a number-control-information screen;

FIG. 10 is an allocation-change screen;

FIGS. 11 and 12 illustrate number-control-information screens;

FIG. 13 is a sequence chart of an allocation-change process;

FIG. 14 is a sequence chart of a supply-request process; and

FIG. 15 is a sequence chart of a borrowing process.

### DETAILED DESCRIPTION OF THE EXAMPLE EMBODIMENTS

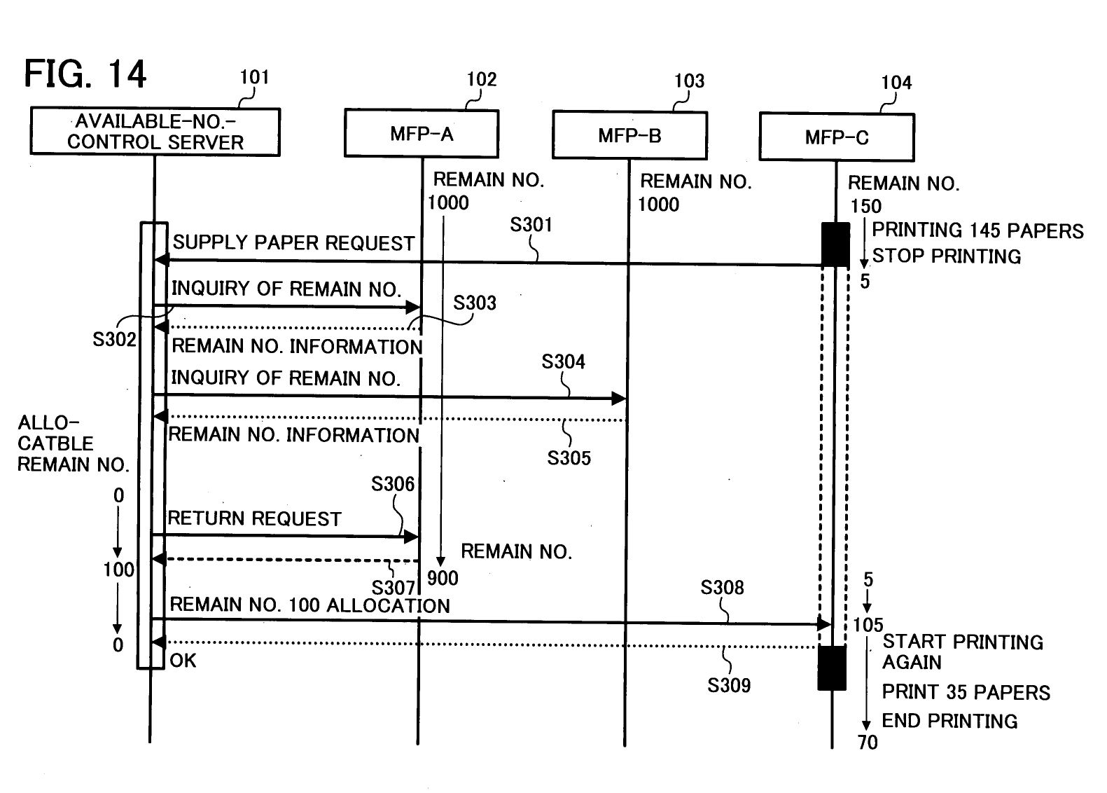

In describing example embodiments illustrated in the drawings, specific terminology is employed for the sake of clarity. However, the disclosure of this patent specification is not intended to be limited to the specific terminology so selected and it is to be understood that each specific element includes all technical equivalents that operate in a similar manner. Referring now to the drawings, wherein like reference numerals designate identical or corresponding parts throughout the several views, particularly to FIG. 14, a method for controlling a system for image forming according to an embodiment of the present invention is described.

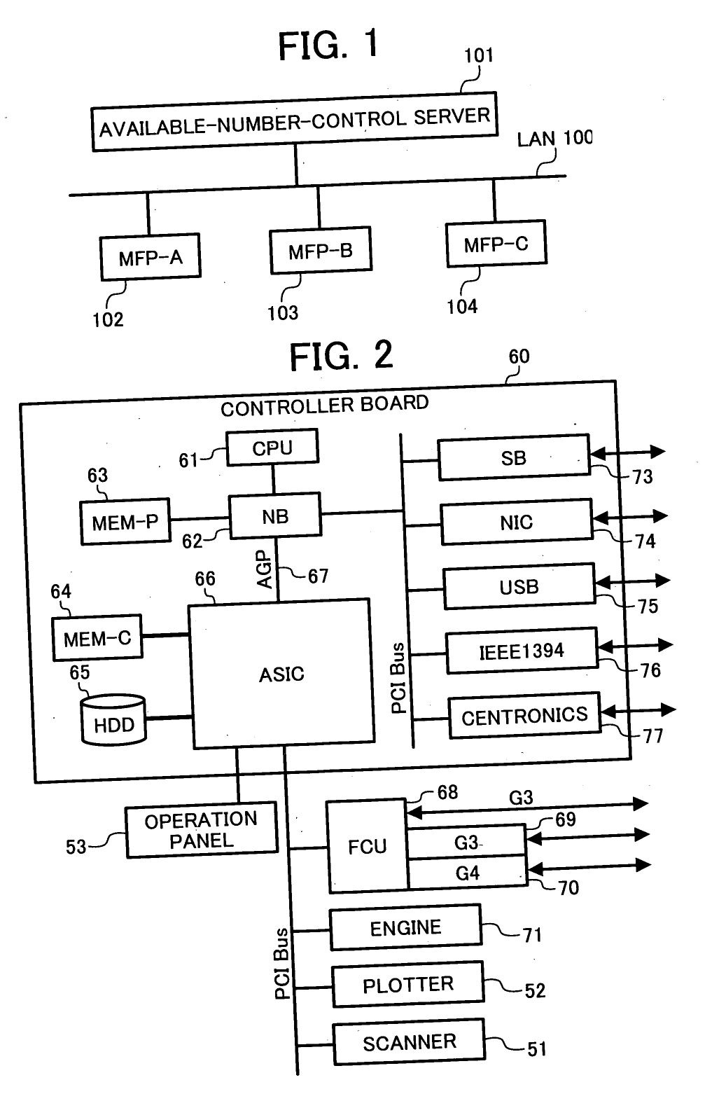

FIG. 1 illustrates a block diagram of an image forming system according to an example embodiment. The image forming system includes an available-number-control server 101, a multi-function-peripheral (MFP) MFP-A 102, a MFP MFP-B 103, a MFP MFP-C 104 and a LAN (local-area-network) 100. The available-number-control server 101 controls a total number of prints printed by the MFPs in the whole system. In this case, the available-number-control server 101 controls the total number of prints printed by the MFP-A 102, the MFP-B 103 and the MFP-C 104.

The MFP MFP-A 102, the MFP MFP-B 103 and the MFP MFP-C 104 are image forming apparatuses which receive an allocation of a print number, within which an image forming apparatus is allowed to print, from the available-number-control server 101. In this example embodiment of an image forming system, MFPs are illustrated, however, standard printers are also applicable.

FIG. 2 is a block diagram of the MFP as an example of the image forming apparatus of FIG. 1. The MFP includes a controller board 60, an operation panel 53, a FCU (facsimile control Unit) 68, an engine 71, a scanner 51 and a plotter 52. The FCU 68 includes a G3 standard support unit 69 and a G4 standard support unit 70.

The controller board 60 includes a CPU (central processing unit) 61, an ASIC (application specific integrated circuit) 66, a HDD (hard disc drive) 65, a local memory MEM-C 64, a system memory MEM-P 63, a north bridge NB 62, a south bridge SB 73, a NIC (network interface card) 74, an USB (universal serial bus) device 75, an IEEE1394 device 76 and a Centronics interface device 77.

The operation panel 53 is connected to the ASIC 66 on the controller board 60. The south bridge SB 73, the NIC 74, the USB device 75, the IEEE1394 device 76, the Centronics interface device 77 are connected to the north bridge NB 62 via a PCI bus. The FCU 68, the engine 71, the scanner 51 and the plotter 52 are connected to the ASIC 66 on the controller board 60 via a PCI bus.

On the controller board 60, the local memory MEM-C 64 and the HDD 65 are connected to the ASIC 66. Further, the CPU 61 is connected to the ASIC 66 via the north bridge NB 62 which is included in a chip set. Using the north bridge NB 62, it is possible to connect even when an specification of an interface for the CPU 61 is not open to the public and is not possible to know because the north bridge NB 62 is designed to fit the interface for the CPU 61. The ASIC 66 is connected to the north bridge NB 62 not via the PCI bus but via an ATG (accelerated graphic port) 67. Thus, it is avoided to degrade a performance by using the high speed ATG, even when more than one jobs are being executed.

The CPU 61 performs a whole system control of the MFP. The CPU 61 boots a program software on an operation system (OS) and executes the program software at each process. The north bridge NB 62 is a bridge device to connect the CPU 61, the system memory MEM-P 63, the south bridge SB 73 and the ASIC 66. The system memory MEM-P 63 is used as a printing memory of the MFP. The south bridge SB 73 is a bridge device for connecting the north bridge NB 62, the PCI bus and peripheral devices. The local memory MEM-C 64 is used as a buffer memory for an image to be copied and is also used as a buffer memory for characters.

The ASIC 66 is a dedicated IC to perform specific functions and includes a hardware element to execute image processing. The HDD 65 is used to store data such as images, documents, programs, fonts and forms. The operation panel 53 is used to receive inputs by user's operation and to display.

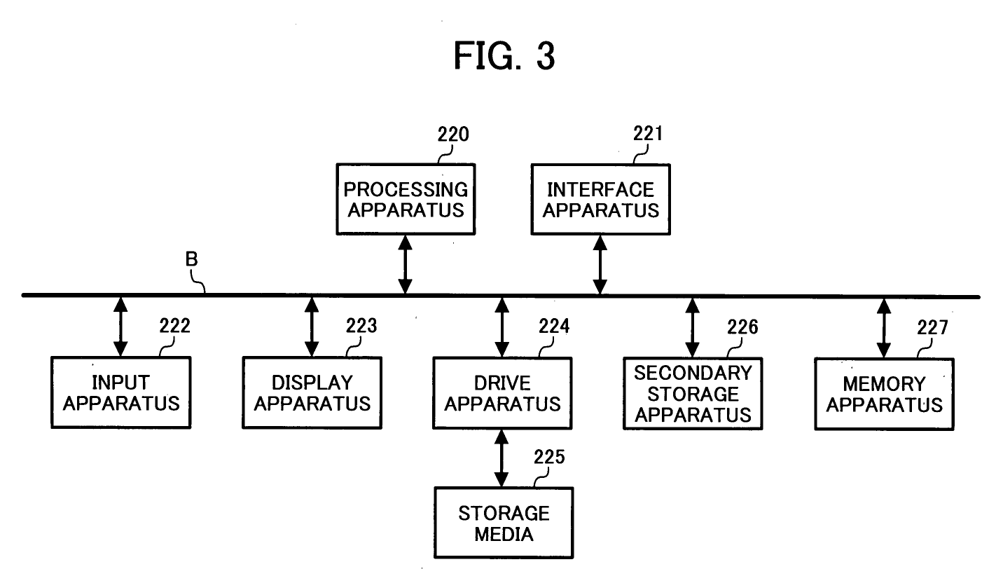

FIG. 3 illustrates a block diagram of a hardware of the available-number-control server 101. The available-number-control server 101 includes an input apparatus 222, a display apparatus 223, a drive apparatus 224, a storage media 225, a secondary storage apparatus 226, a memory apparatus 227, a processing apparatus 220 and an interface apparatus 221. The apparatuses and the memory etc. in the available-number-control server 101 are connected each other through a PCI bus.

The input apparatus 222 includes a keyboard and a mouse to input a variety of input operation signals. The display apparatus 223 displays a variety of input windows and data necessary to operate the available-number-control server 101. The interface apparatus 221 is configured to connect the available-number-control server 101 to a network and to connect to other equipment located at outside. The interface apparatus 221 is comprising a NIC (network interface card), a modem and a USB (universal serial bus).

A program software to operate the available-number-control server 101 is provided with the storage medium 225 such as CD-ROM, or is downloaded through a network. The storage medium 225 are set in the drive apparatus 224. Then, data and program are read from the storage medium 225 and are installed into the secondary storage media 226 through the drive apparatus 224.

The secondary storage media 226 stores necessary files together with the data and the program. The memory apparatus 227 stores the program which is read from the secondary storage media 226 when the available-number-control server 101 is booted. The processing apparatus 220 executes processing in accordance with the program stored in the memory apparatus 227.

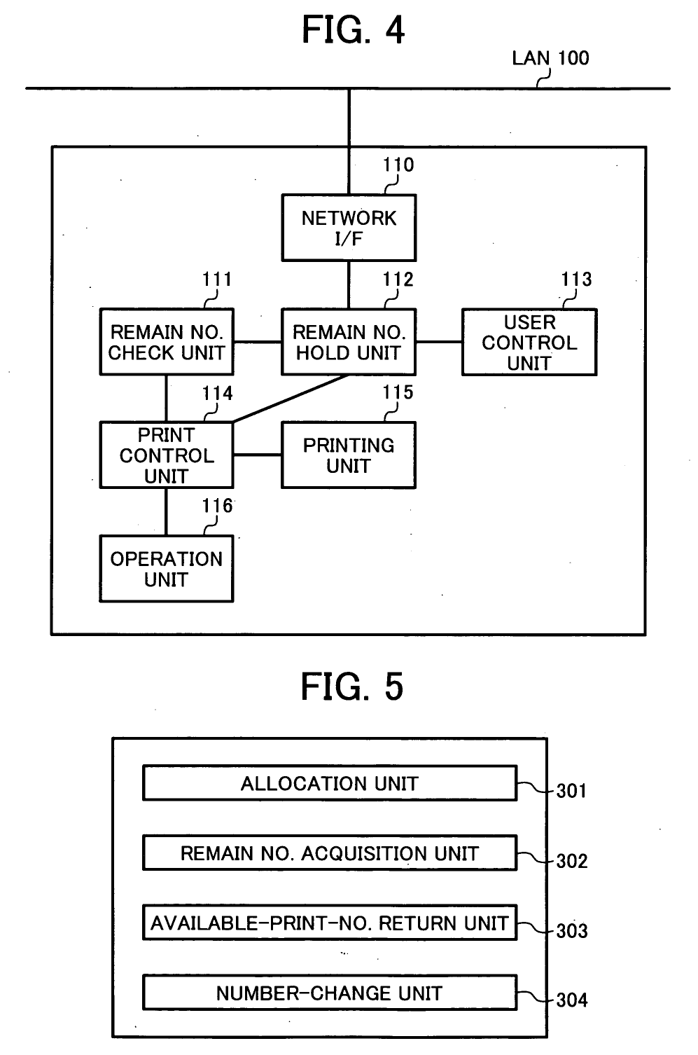

FIG. 4 illustrates a hardware block diagram of a client MFP. The MFP includes a network interface (I/F) 110, a remain-number-check unit 111, a remain-number-hold unit 112, a user control unit 113, a print-control unit 114, a printing unit 115 and an operation unit 116.

The remain-number-check unit 111 checks an available number to print (remain number) and sends a checked result to the print-control unit 114 and the remain-number-hold unit 112. The remain-number-hold unit 112 holds the remain number. The print-control unit 114 provides the remain number to the available-number-control server 101.

The print-control unit 114 controls a printing process in accordance with the information of the remain number. Further, the print-control unit 114 sends a supplementary request to increase the print number to the available-number-control server 101. If the print-control unit 114 recognizes that the print number is not enough, the print-control unit 114 sends a request to borrow a print number from the available-number-control server 101 for further printing operation.

Moreover, the print-control unit 114 can return a number obtained by subtracting the number of prints made at the MFP from the print number of prints allowed to be produced. The print-control unit 114 can also return a whole print number, or a part of the print number. The printing unit 115 performs printing operation in accordance with an instruction from the print-control unit 114. The user-control unit 113 manages user names and user ID (identification) registered in the MFP. The operation unit 116 performs the operations which are explained using FIG. 2.

FIG. 5 illustrates a software block of the available-number-control server 101. The software block of the available-number-control server 101 includes an allocation unit 301, a remain-number-acquisition unit 302, a print-number-return unit 303 and a number-change unit 304.

The allocation unit 301 allocates each print number, within which the MFP is allowed to print, to the each MFP. The remaining-number-acquisition unit 302 additionally acquires a remain number which is an available number to print at the MFP at the moment. The print-number-return unit 303 returns a whole of the print number, or a part of the print number. The number-change unit 304 changes the print number by an user's instruction.

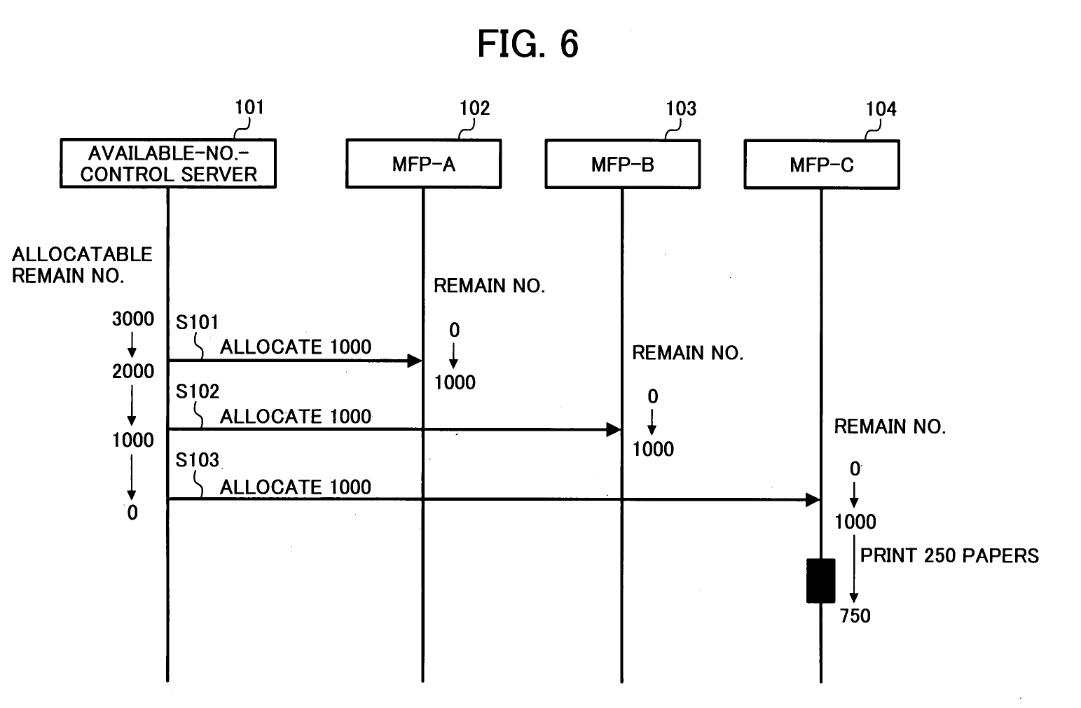

FIG. 6 illustrates a sequence of an allocation process to allocate print numbers to the MFPs. In this sequence of the allocation process, the available-number-control server 101 allocates the print numbers to the MFP MFP-A 102, the MFP MFP-B 103 and the MFP MFP-C 104. At the beginning, a number of “3000” is provided as a total print number for an user which is registered as [user] and is available for the three MFPs.

An allocatable-remain number is defined as a print number which is not allocated by the available-number-control server 101 yet. A remain number is defined as a number which is currently allowed to print at a MFP.

At a step S101, the available-number-control server 101 allocates a number of “1000” as a print number to the MFP MFP-A 102. The allocatable-remain number for the user becomes a number of “2000” and the remain number at the MFP MFP-A 102 is a number of “1000”.

At a step S102, the available-number-control server 101 allocates a number of “1000” as a print number to the MFP MFP-B 103. Then, the allocatable-remain number for the user becomes a number of “1000” and the remain number at the MFP-B 103 is a number of “1000”.

At a step S103, the available-number-control server 101 allocates a number of “1000” as a print number to the MFP MFP-C 104. As a result, the allocatable-remain number for the user becomes a number of “0” and the remain number at the MFP MFP-C 104 is a number of “1000”.

After the allocation, when 250 papers are printed out at the MFP MFP-C 104 in accordance with an order by the user, the remain number at the MFP-C 104 then becomes a number of “750”.

The steps 102, 103 and 104 in FIG. 6 are the allocation steps of the print number. In this example embodiment, an equal number is allocated to all three MFPs and the allocatable-remain number becomes a number of “0” finally. However, the allocatable-remain number is not necessary to be a number of “0” at the last allocation step, but can be a finite number. After the print numbers for the MFPs are allocated, the user can start to use the MFP by logging in the MFP.

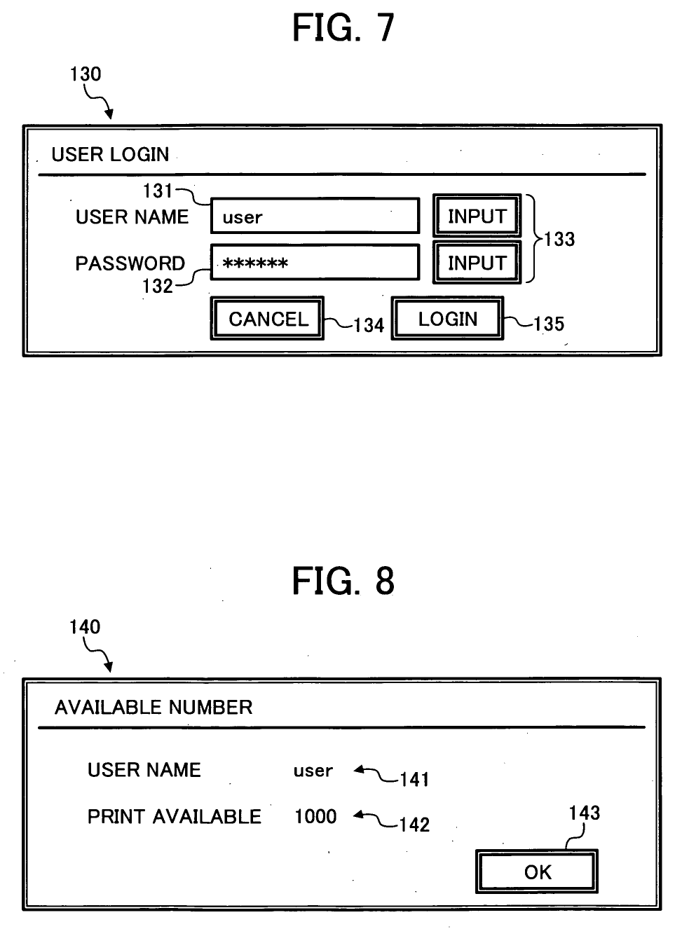

FIG. 7 illustrates an user-login screen which is displayed at the MFP. In the user-login screen 130, a user-name input field 131, a password input field 132, [Input] buttons 133, a [cancel] button 134 and a [login] button 135 are indicated.

The user-name input field 131 is used to input an user name. The password input field 132 is used to input a password. The [Input] buttons 133 are pushed to input the user name or the password. The [cancel] button 134 is pushed to cancel the user login screen. The [login] button 135 is pushed to login with the user name and the password input.

When the login process is completed successfully, an available-number-conformation screen 140 is displayed as shown in FIG. 8. In the available-number-conformation screen 140, an user name 141 which performs a login and print number 142 are displayed. In FIG. 8, the [user] is displayed as the user name and a number of “1000” is displayed as a print number. When a [OK] button 143 is pushed on this screen, the MFP becomes ready to use. The user can change the available number of the printing which was allocated by the available-number-control server 101.

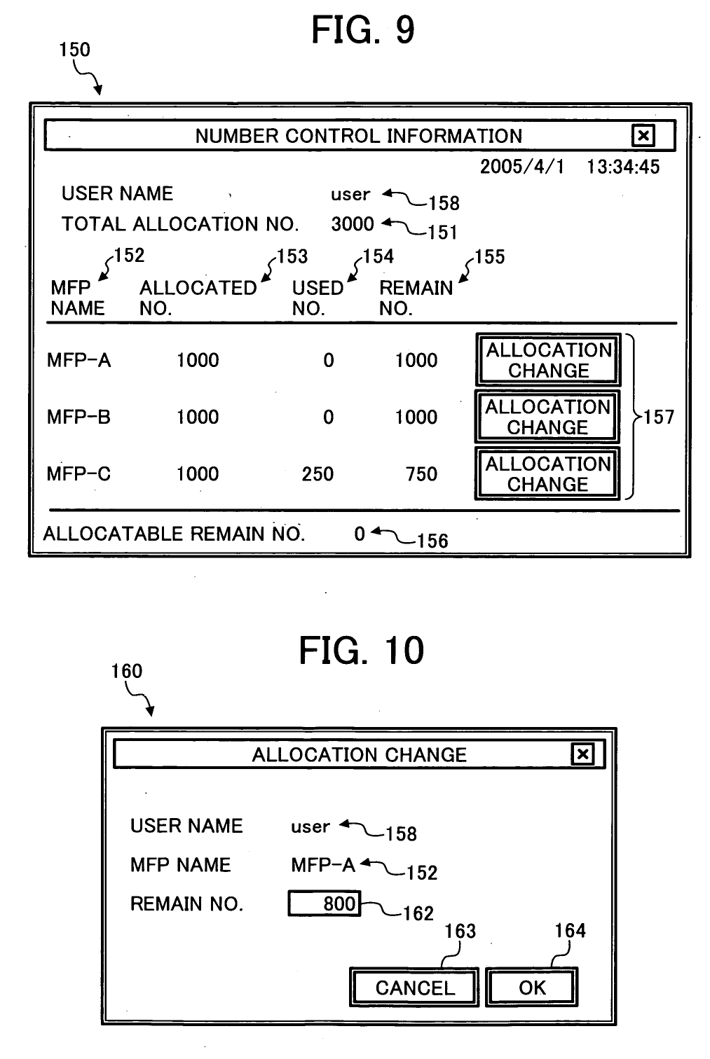

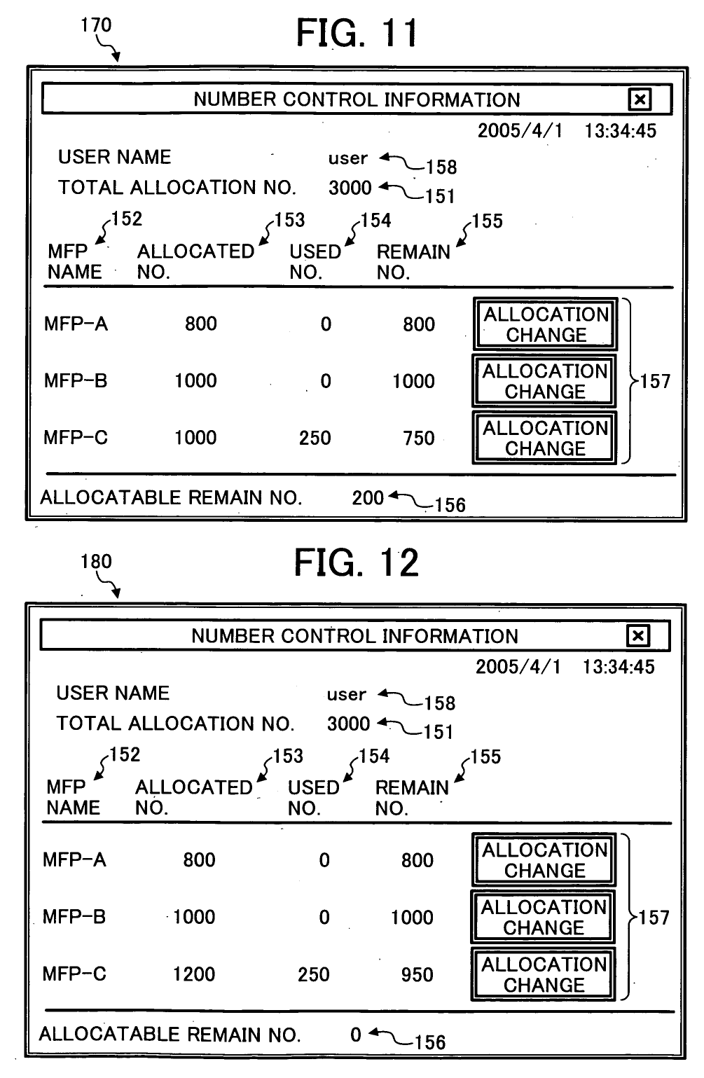

An user interface of this process will be described. The user interface is displayed on the available-number-control server 101. FIG. 9 illustrates a number-control-information screen 150. In the number-control-information screen 150, an user name 158, a total allocation number 151, a printer name 152, an allocated number 153, an used number 154, a remain number 155, an allocatable-remain number 156 and [allocation change] buttons 157 are indicated.

The total allocation number 151 is a total number to be allowed to print and is allocated to the user assigned by the user name 158. The printer name 152 is the name of the MFP. The allocated number 153 is a print number allocated to the MFP. The used number 154 shows the number of prints which have been already printed at the MFP. The remain number 155 shows the number which are not used at the MFP. The allocatable-remain number 156 shows the number which is not allocated to the MFPs yet.

The [allocation change] button 157 is configured to change the print number allocated to the MFP. The user can change the print number allocated by the available-number-control server 101.

FIG. 10 illustrates an allocation-change screen 160 when the [allocation change] button 157 for the MFP MFP-A 102 is pushed. The allocation-change screen 160 shows a case in which the user is changing the print number of the MFP MFP-A 102 to a number of “800”. In the allocation-change screen 160, the user name 158, the printer name 152, a remain number input field 162, a [cancel] button 163 and a [OK] button 164 are indicated. The [cancel] button 163 is pushed if the input of this screen is to be canceled.

The user inputs “800” at the remain number input field 162 in the screen 160 (shown in FIG. 10) to change the remain number of the MFP MFP-A 102 from a number of “1000” to a number of “800”. When the user pushes the [OK] button 164, a screen 170 will be displayed. The remain number is changed to a number of “800” as shown at the indication of the remain number 155. Further, the allocatable-remain number 156 is increased from a number of “0” to a number of “200” because the MFP MFP-A 102 returned a number of “200” to the available-number-control server 101.

After that, if the user opens the allocation-change screen 160 shown in FIG. 10 and allocates the allocatable-remain number “200” to the MFP MFP-C 104, the remain number 155 of the MFP MFP-C 104 is changed from a number of “750” to a number of “950” and the allocatable-remain number 156 is back again to a number of “0” as shown in FIG. 12.

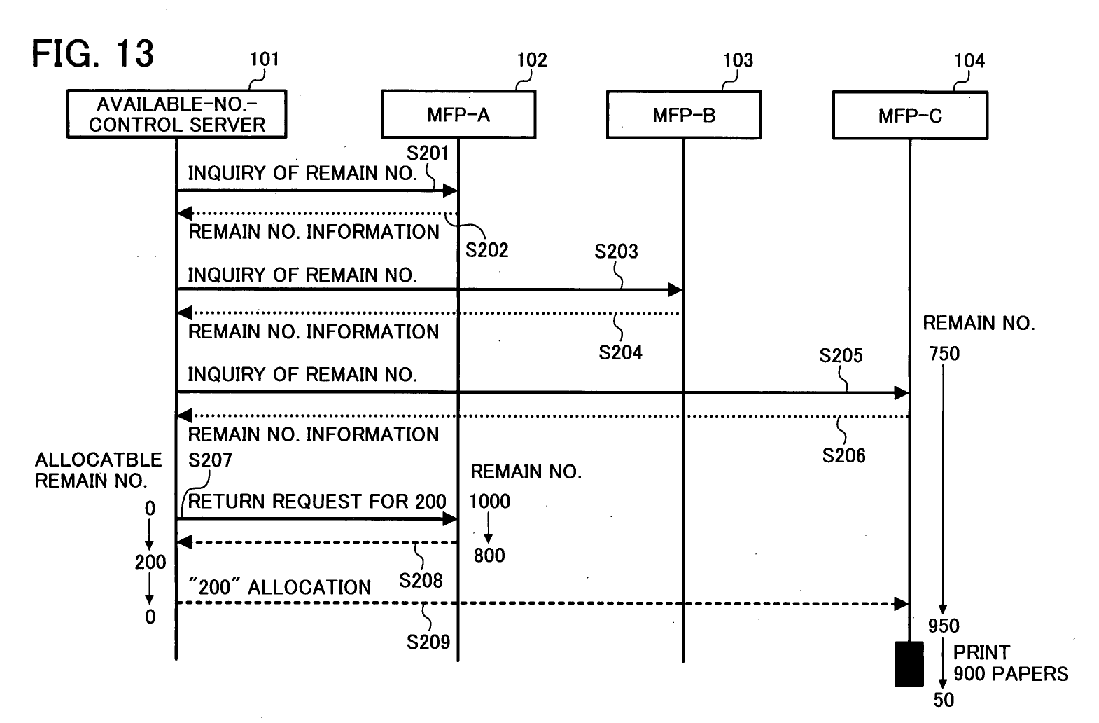

FIG. 13 illustrates a sequence of an allocation change process performed at the available-number-control server 101 and each MFP.

At a step S201, the available-number-control server 101 sends an inquiry of remain number information to the MFP MFP-A 102. At a step S202, the MFP MFP-A 102 provides the remain number information to the available-number-control server 101. The step S202 is a remain number providing step for the MFP MFP-A 102 and is a number acquisition step for the available-number-control server 101.

Similarly, At a step S203, the available-number-control server 101 sends an inquiry of a remain number information to the MFP-B 103. At a step S204, the MFP MFP-B 103 provides the remain number information to the available-number-control server 101. Further, at a step S205, the available-number-control server 101 sends an inquiry of a remain number information to the MFP MFP-C 104. At a step S206, the MFP MFP-C 104 provides the remain number information to the available-number-control server 101.

At a step S207, the available-number-control server 101 sends a return request of a number of “200” to the MFP MFP-A 102. At a step S208, the MFP MFP-A 102 return the number of “200” to the available-number-control server 101. The step S207 and S208 correspond to a returning print-available-number step in which the MFP returns a whole print number or a part of the print number. And the step S207 and S208 correspond to a changing number step because this is a change by an user.

With these steps, at first, the remain number is changed from a number of “1000” to a number of “800” and the allocatable-remain number is changed from a number of “0” to a number of “200”. Secondly, at a step S209, the available-number-control server 101 allocates a number of “200” to the MFP MFP-C 104.

By this allocation, the allocatable-remain number is changed from a number of “200” to a number of “0” and the remain number at the MFP MFP-C 104 is changed from a number of “750” to a number of “950”. Then, when 900 papers are printed at the MFP MFP-C 104, the remain number at the MFP MFP-C 104 becomes a number of “50”. When the MFP recognizes the MFP does not have enough print number for printing, the MFP sends a request to supply a supplemental print number to the available-number-control server 101.

FIG. 14 illustrates a sequence of a supply-request process. In this example embodiment, print numbers which the MFPs hold are a number of “1000” at the MFP MFP-A 102 and the MFP MFP-B 103 and a number “150” at the MFP MFP-C 104 at the beginning. When the MFP MFP-C 104 have made 145 prints, the remain number at the MFP MFP-C 104 becomes a number of “5”.

At a step S301, when the remain number becomes a number of “5” at the MFP-C 104, the MFP-C 104 stops printing and sends a supply-number request to the available-number-control server 101. The step S301 corresponds to a supply-number request step. The remain number of “5” can be determined beforehand. Further, another number may be used besides a number of “5”.

At a step S302, the available-number-control server 101 sends an inquiry of the remain number information of the MFP MFP-A 102 in accordance with the supply-number request. At a step S303, the MFP MFP-A 102 provides the remain number information to the available-number-control server 101.

Similarly, at a step S304, the available-number-control server 101 sends an inquiry of a remain number information to the MFP MFP-B 103. At a step S305, the MFP MFP-B 103 provides the remain number information to the available-number-control server 101. Further, at a step S306, the available-number-control server 101 sends a return request to return a number of “100” to the MFP MFP-A 102. At a step S307, the MFP MFP-A 102 returns a number of “100” to the available-number-control server 101. with these steps, the remain number of the MFP MFP-A 102 is changed from a number “1000” to a number “900”.

Then, at a step S308, the available-number-control server 101 allocates a number of “100” to the MFP MFP-C 104. At a step S309, the MFP MFP-C 104 returns a comment of “OK”. With these steps, the allocatable-remain number is changed from a number of “100” to a number of “0” and the remain number of the MFP-C 104 is changed from a number of “5” to a number of “105”. The MFP MFP-C 104 now has an increased number of the remain number and starts printing again. The MFP MFP-C 104 prints 35 papers and then finalizes a printing operation.

At the step S306, it is possible to set a variety of settings to which MFP the return request is to be sent. For example, the return requests are always to be sent to a fixed MFP, or to a MFP which has the largest print number. In the case of FIG. 14, the MFP MFP-C 103 can also be selected to be sent a return request because the MFP MFP-A 102 and the MFP MFP-B 103 have same print number and only the MFP MFP-C 104 has a different print number.

Further, when a return request is sent, a variety of settings on the request number are also possible. In the case of FIG. 14, the request number is fixed to a number of “100”. It may be possible to be a number of “200”. Also, it may be possible to be a number of 10 percent of the remain number of the MFP. According to the procedure, it is possible to print out even when the remain number at a MFP becomes insufficient for the further printing operation. FIG. 14 illustrates the case in which a print number is requested and a supplemental print number is supplied after the printing operation was performed.

In a next procedure, a print number is borrowed in advance before a printing operation and is returned after the printing operation.

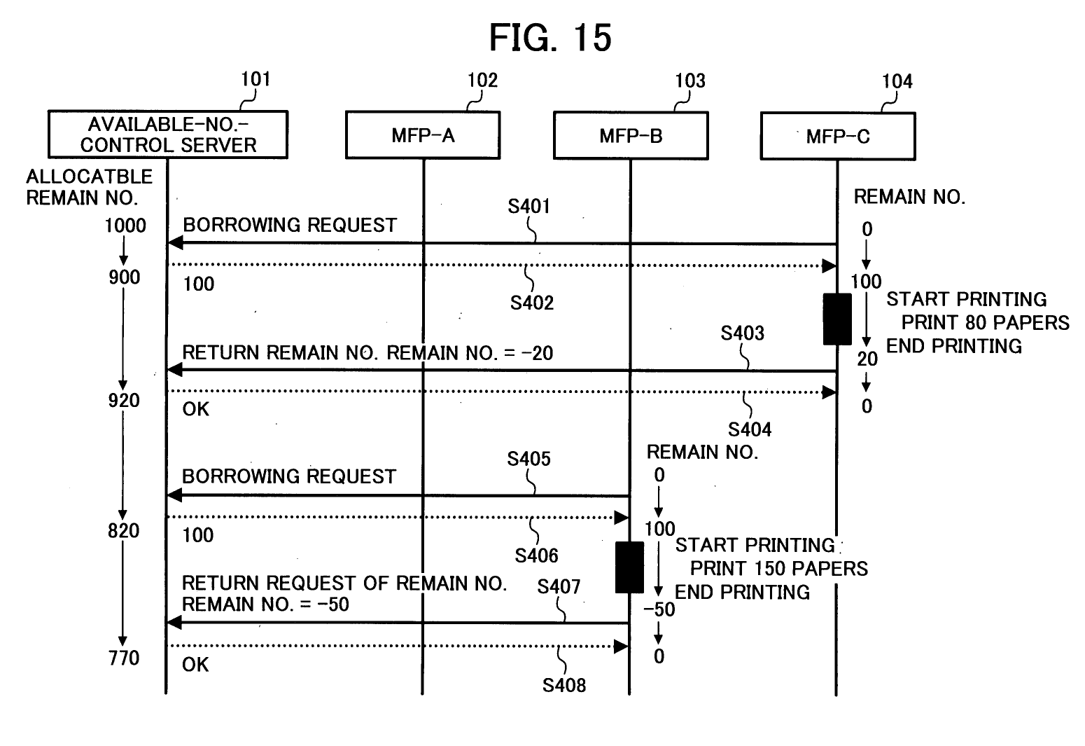

FIG. 15 illustrates a sequence of a borrowing process in which the MFP MFP-B 103 and the MFP MFP-C 104 borrow a print number.

At a step S401, the MFP MFP-C 104 sends a borrowing request to the available-number-control server 101. The step S401 corresponds to a borrowing step to borrow the print number.

At a step S402, the available-number-control server 101 lends a number of “100” to the MFP MFP-C 104. With this process, the remain number of the MFP MFP-C 104 becomes a number of “100” and the available-remain number of the available-number-control server 101 is a number of “900”. When the MFP MFP-C 104 have made 80 prints, the remain number becomes a number of “20”.

At a step S403, the MFP MFP-C 104 returns the number of “20” to the available-number-control server 101. The step S403 corresponds to a return-borrowing step to return a number obtained by subtracting the number of prints made at the MFP from the number of prints allowed to be produced.

At a step S404, the available-number-control server 101 returns a comment of “OK”. With these steps, the remain number of the MFP MFP-C 104 becomes a number of “0” and the allocatable-remain number becomes a number of “920”.

At a step S405, the MFP MFP-B 103 sends a borrowing request to the available-number-control server 101. At a step S406, the available-number-control server 101 lends a number of “100” to the MFP MFP-B 103. With this process, the remain number of the MFP MFP-B 103 becomes a number of “100” and the available-remain number of the available-number-control server 101 is a number of “820”.

When the MFP MFP-B 103 have made 150 prints which is more than the borrowed number “100” which is the available print number, the remain number becomes a number of “−50”. (=100-150) At a step S407, the MFP-B 103 returns the number of “−50” to the available-number-control server 101.

At a step S408, the available-number-control server 101 returns a comment of “OK”. With this step, the remain number of the MFP MFP-C 104 becomes a number of “0” and the allocatable remain number becomes a number of “770”. (=820+(−50))

By this procedure, any number of printing becomes possible even when the necessary number of printing is not allocated in advance. The number to be lent can be set in advance, or can be requested from the MFP.

Embodiments of this invention may be conveniently implemented using a conventional general purpose digital computer programmed according to the teachings of the present specification, as will be apparent to those skilled in the computer art. Appropriate software coding can readily be prepared by skilled programmers based on the teachings of the present disclosure, as will be apparent to those skilled in the software art. Embodiments of the present invention may also be implemented by the preparation of application specific integrated circuits or by interconnecting an appropriate network of conventional component circuits, as will be readily apparent to those skilled in the art.

Numerous additional modifications and variations are possible in light of the above teachings. It is therefore to be understood that within the scope of the appended claims, the disclosure of this patent specification may be practiced otherwise than as specifically described herein.

Any of the aforementioned methods may be embodied in the form of a system or device, including, but not limited to, any of the structure for performing the methodology illustrated in the drawings.

Further, any of the aforementioned methods may be embodied in the form of a program. The program may be stored on a computer readable media and is adapted to perform any one of the aforementioned methods when run on a computer device (a device including a processor). Thus, the storage medium or computer readable medium, is adapted to store information and is adapted to interact with a data processing facility or computer device to perform the method of any of the above mentioned embodiments.

The storage medium may be a built-in medium installed inside a computer device main body or a removable medium arranged so that it can be separated from the computer device main body. Examples of the built-in medium include, but are not limited to, rewriteable non-volatile memories, such as ROMs and flash memories, and hard disks. Examples of the removable medium include, but are not limited to, optical storage media such as CD-ROMs and DVDs; magneto-optical storage media, such as MOs; magnetism storage media, such as floppy disks (trademark), cassette tapes, and removable hard disks; media with a built-in rewriteable non-volatile memory, such as memory cards; and media with a built-in ROM, such as ROM cassettes.

Example embodiments being thus described, it will be obvious that the same may be varied in many ways. Such variations are not to be regarded as a departure from the spirit and scope of the present invention, and all such modifications as would be obvious to one skilled in the art are intended to be included within the scope of the following claims.

This patent specification is based on Japanese patent application, No. 2005-064145 filed on Mar. 8, 2005 in the Japan Patent Office, the entire contents of which are incorporated by reference herein.

What is claimed is:

1. A method for controlling an image forming apparatus of a plurality of image forming apparatuses connected to a server, comprising:
registering a print number, within which the image forming apparatus is allowed to print, allocated from the server; and
decrementing by one from the print number upon each performance of printing.

2. The method according to claim 1, further comprising:
requesting an additional print number to the server;
receiving a supplementary print number which the server obtains from another image forming apparatus; and
adding the supplementary print number to the print number.

3. The method according to claim 2, wherein the image forming apparatus sends a request when the print number becomes equal to or lower than a predetermined number.

4. The method according to claim 2, further comprising,
returning to the server with a number obtained by subtracting the number of prints performed at the image forming apparatus from the supplementary print number.

5. The method according to claim 1, further comprising,
returning to the server with at least a part of the print number allocated from the server.

6. The method according to claim 1, wherein the image forming apparatus is allowed to print more than the print number allocated from the server.

7. The method according to claim 6, further comprising,
returning to the server with a minus number obtained by subtracting the number of prints performed at the image forming apparatus from the print number.

8. The method according to claim 1, further comprising:
receiving an inquiry to inform a remaining print number from the server;
sending the remaining print number to the server;
receiving an order to provide a required print number from the server; and
providing the required print number to the server.

9. A method for controlling a server for a plurality of image forming apparatuses including first and second image forming apparatuses connected to the server, comprising:
allocating a print number, within which an image forming apparatus is allowed to print, to each image forming apparatus;
receiving a request of an additional print number from the first image forming apparatus;
sending an inquiry to a second image forming apparatus to inform a remaining print number of the second image forming apparatus;
receiving the information of the remaining print number of the second image forming apparatus;
sending an order to provide a required print number to the second image forming apparatus;
receiving the required print number provided from the second image forming apparatus; and
allocating the print number provided from the second image forming apparatus to the first image forming apparatus.

10. The method according to claim 9, wherein the required print number provided from the second image forming apparatus is at least a part of the remaining print number of the second image forming apparatus.

11. A method for controlling an image forming system having a plurality of image forming apparatuses including first and second image forming apparatuses connected to a server, comprising:
allocating a print number, within which an image forming apparatus is allowed to print, to each image forming apparatus by a server;
requesting an additional print number from the first image forming apparatus to the server;
sending an inquiry to inform a remaining print number of a second image forming apparatus from the server;
returning the information of the remaining print number of the second image forming apparatus to the server;
sending an order to provide a required print number to the second image forming apparatus;
providing the required print number from the second image forming apparatus to the server; and
allocating the print number provided from the second image forming apparatus to the first image forming apparatus.

12. A computer program product stored on a computer readable storage medium for, when run on a data processing apparatus, carrying out the method comprising:
allocating a print number, within which an image forming apparatus is allowed to print, to each image forming apparatus by a server;
requesting an additional print number from the first image forming apparatus to the server;
sending an inquiry to inform a remaining print number of a second image forming apparatus from the server;
returning the information of the remaining print number of the second image forming apparatus to the server;
sending an order to provide a required print number to the second image forming apparatus;
providing the required print number from the second image forming apparatus to the server; and
allocating the print number provided from the second image forming apparatus to the first image forming apparatus.

13. A computer readable medium that stores a computer program product for, when run on a data processing apparatus, carrying out the method comprising:
allocating a print number, within which an image forming apparatus is allowed to print, to each image forming apparatus by a server;
requesting an additional print number from the first image forming apparatus to the server;
sending an inquiry to inform a remaining print number of a second image forming apparatus from the server;
returning the information of the remaining print number of the second image forming apparatus to the server;
sending an order to provide a required print number to the second image forming apparatus;
providing the required print number from the second image forming apparatus to the server; and
allocating the print number provided from the second image forming apparatus to the first image forming apparatus.

14. A method for controlling a server for a plurality of image forming apparatuses, comprising:
registering a print number, within which the image forming apparatus is allowed to print, allocated from the server; and
decrementing by one from the print number upon each performance of printing.

15. A computer program, adapted to, when executed on a computer, cause the computer to carry out the method as claimed in claim 1.

16. A computer program product, including the computer program of claim 15.

17. A computer readable medium including program segments for, when executed on a computer, causing the computer to implement the method of claim 1.

18. A computer program, adapted to, when executed on a computer, cause the computer to carry out the method as claimed in claim 14.

19. A computer program product, including the computer program of claim 18.

20. A computer readable medium including program segments for, when executed on a computer, causing the computer to implement the method of claim 14.
